(19) United States
(12) Patent Application Publication
(10) Pub. No.: US 2009/0251277 A1
(43) Pub. Date: Oct. 8, 2009

(54) Content selection

(76) Inventors: Kenton O'Hara, Bristol (GB); Timothy Kindberg, Bristol (GB)

Correspondence Address: HEWLETT-PACKARD COMPANY;Intellectual Property Administration, 3404 E. Harmony Road, Mail Stop 35, FORT COLLINS, CO, 80528, US

(21) Appl. No.: 12/417,582

(22) Filed: Apr. 2, 2009

(30) Foreign Application Priority Data
Apr. 3, 2008 (GB) 0806071.7

(51) Int. Cl. G05B 19/00

(52) U.S. Cl. 340/5.1

(57) ABSTRACT

A content selection system for selecting content for delivery to a group of users in a space is provided. The system comprises inputs arranged to receive a plurality of identifier tags, each identifier tag being arranged to uniquely identify a user, data storage apparatus arranged to store content for selection, a processor arranged to select content and outputs arranged to output the selected content to a content output device. The processor is arranged to check each identifier tag received by the input means against a plurality of stored content profiles, each content profile comprising a user's identifier tag and data relating to the user's content preferences. The processor is also arranged to select content from the data storage apparatus based on content preference data from stored content profiles that have an identifier tag that matches one of the received plurality of identifier tags.

### RELATED PATENT APPLICATIONS

The present patent application claims priority under 35 USC 119 to the previously filed United Kingdom patent application filed on Apr. 3, 2008, and assigned serial no. 0806071.7.

### FIELD OF THE INVENTION

The present invention relates to content selection. In particular, but not exclusively, the invention relates to content selection systems and methods for selecting content for delivery to a group of users in a space.

### BACKGROUND TO THE INVENTION

Systems for delivering media content to a group of people in a public or shared space are commonplace. For example, video display screens in public areas may be used to show news clips, advertisements and so on. Similarly, music is often played in public spaces such as cafes, restaurants and bars, as well as in retail spaces, leisure centres and similar environments. In all of these cases, a function of the system is to provide relevant information or entertainment to the individuals within the audience group. Often, a computer-controlled system is employed to store, retrieve and deliver the media content to a suitable output device.

In many cases, the selection of content to be delivered is determined solely by an operator of the system. For example, the content displayed on a public video screen may be pre-selected by an operator. Similarly, the music played in a bar may be chosen by the staff, who operate a music-playing system.

In such cases, it is often an aim of the person responsible for selecting the content to choose content which matches, or reflects, the preferences of the largest possible number of individuals within the audience group. For example, a person responsible for the selection of video advertisements to be displayed on a public video screen might seek to select those advertisements he or she expects to appeal to a majority of the audience group in the vicinity of the screen at the relevant time.

Similarly, a person responsible for the selection of music to be played in a bar may have the musical tastes of the bar's customers in mind.

In practice, the individuals within the audience group may have different preferences to one another, and those preferences might span a broad range of tastes. The selection of media content that appeals to everyone in the audience group is therefore difficult. Furthermore, individuals may enter and leave the audience group over time, and consequently the distribution of preferences may be constantly changing.

So, when a staff member chooses the music played to the audience group, he or she will choose according to either his or her own tastes, or will choose music which, in their opinion, is most likely to be acceptable to the majority of the audience group present at that time.

Such an arrangement has a number of disadvantages. The audience group as a whole has no direct control or influence over the media delivery system. In some situations, such as in a bar or restaurant, individuals within the audience group may seek to influence the content selection by expressing their preferences to the person responsible for making the selection. In other situations, such as the display of video in a public space, such interaction might not be possible.

Either way, the absence of a means of effectively influencing or expressing a preference as to the media content delivered increases the risk that those members of the audience group who are dissatisfied with the selection will divert their attention away from the media content or even leave the space. Consequently, the task of selecting appropriate media for engaging the attention of, or entertaining, a changing audience group can become burdensome for the responsible person.

A number of existing systems allow members of an audience group to select or influence the media content delivered to them, thus addressing the above problem.

For example, a jukebox allows an individual to select one or more music tracks to be played from a number of available tracks. Usually, a charge is made for each track selected. Although some degree of control is possible by limiting the available tracks to a pre-selected set, the whole audience group is subjected to the choice of one individual. Thus, the preferences of the majority of the audience group are, largely, not taken into account. Jukeboxes are often considered to be unsuitable for many environments for that reason.

Other systems have been developed which are designed to take account of the preferences of a majority of, rather than an individual member of, an audience group.

In one such system, data representing the preferences of individual users of a public space is stored on a central database. Users register their entry into the space by way of an identity card and reader arrangement. The pre-stored preference data for the current users of the space, i.e. the current audience group, can be retrieved and input to a suitable algorithm which outputs a selection of media content which is, as far as is possible, aligned with the preferences of the audience group.

While this system is capable of taking account of the preferences of all of the users of the space, it requires each user to explicitly register their preferences in advance for storage on the database. Furthermore, users must to register their presence in the space in order for their preferences to be taken into account, and registration itself requires relatively complex and expensive hardware in the form of identity cards. It is therefore not suitable for use in spaces which do not have a regular group of users.

In another system, members of the audience group are provided with voting devices. The voting devices display a small number of options for media content to be delivered. For example, when used in a bar or similar environment, the voting devices may display a small number of music tracks to be played next. Individuals within the audience group indicate their preference for the media content to be delivered by selecting one of the options, and the voting devices send the selection information to a central computer. The central computer processes the selection information to determine the most popular option, and the appropriate media content is then scheduled for delivery.

Again, this system requires a complex and expensive hardware set-up including, in some circumstances, a large number of voting devices.

Furthermore, in many environments, it is not appropriate to require users to vote or register their presence in a space. For instance, where video screens are installed in urban environments such as railway stations, individuals in the audience may be present for only a few minutes, and they would be unlikely to take the time to actively indicate their content preferences. Nevertheless, it would be desirable for the preferences of individual members of the audience group to be taken into account when selecting content for display on the screen.

It is against this background that the present invention has been devised.

### SUMMARY OF THE INVENTION

In accordance with one embodiment of the present invention, there is provided a content selection system for selecting content for delivery to a group of users in a space, the system comprising input means arranged to receive a plurality of identifier tags, each identifier tag being arranged to uniquely identify a user; data storage means arranged to store content for selection; a processor arranged to select content; and output means arranged to output the selected content to a content output device. The processor is arranged to check each identifier tag received by the input means against a plurality of stored content profiles, each content profile comprising a user's identifier tag and data relating to the user's content preferences. The processor is also arranged to select content from the data storage means based on content preference data from stored content profiles that have an identifier tag that matches one of the received plurality of identifier tags. The output means may be a media player. For example, the output means may be a video screen installed in the space.

Conveniently, the content stored in the data storage means or data store is associated with metadata, and the content preference data of the content profiles may be compatible with the metadata.

The input means may be arranged to receive the plurality of identifier tags from a wireless personal area network (WPAN) transceiver, in which case each identifier tag may relate to a user's mobile communication device, such as a user's mobile telephone.

Preferably, the WPAN transceiver is a Bluetooth transceiver and the mobile device is a Bluetooth-enabled device. In this case, the identifier tag may conveniently be a Bluetooth device address of the mobile device, which provides unique identification of the Bluetooth-enabled device.

Mobile devices with built-in WPAN capabilities are increasingly commonplace, and many mobile cellular telephones are equipped with Bluetooth transceivers for radio-frequency WPAN communication. The Bluetooth system allows communication between devices equipped with Bluetooth transceivers over a range of approximately 10 m.

The Bluetooth communications standard provides for device addresses, sometimes designated BD_ADDR. The device address associated with a Bluetooth transceiver is factory-set, and uniquely identifies the transceiver. In other words, no two Bluetooth transceivers should, in principle, share a common device address. In embodiments of the invention in which the mobile device is a Bluetooth-enabled device, therefore, the Bluetooth device address is ideally suited to be used as the identifier tag.

It is not usually necessary for a user to install additional software on a Bluetooth-equipped mobile device to allow the Bluetooth address to be transmitted to another Bluetooth-equipped device. Furthermore, Bluetooth-equipped mobile devices are commonplace and are typically carried with their users. Use of such devices to provide identifier tags for users in embodiments of the present invention is therefore convenient.

The content preference data used by the processor in the selection of content may be classified by content category, in which case the processor may be arranged to select content according to the most preferred content category. For example, the content preference data of each content profile may contain a preferred content category description selected from a number of available content category descriptions, such that the most preferred content category is taken as the category that corresponds to the description contained in the greatest number of content profiles.

Rather than selecting content according to the most preferred content category, the processor may instead be arranged to select content based on a statistical analysis of the content preference data. The statistical analysis may, for example, allow selection of the second most preferred content category, the third most preferred content category, and so on. Alternatively, or in addition, the system may be arranged to record the time at which an identifier tag was detected, and the statistical analysis may include statistically weighting the content preference data according to the time elapsed since the identifier tag was detected.

The system may be arranged to retrieve stored content profiles from a remote source. The remote source may, for example, be a network server or internet server. Accordingly, the system may be connected to the remote source via a network such as the internet.

In another embodiment of the invention, a system for delivering content to a group of users in a space is provided. The system comprises a content selection system as described above, and a user detection system arranged to detect identifier tags corresponding to users in the space and to provide the detected identifier tags to the input means of the content selection system.

The identifier tags may comprise device addresses, for example Bluetooth device addresses, of user's mobile devices, and the user detection system may comprise one or more detectors arranged to detect mobile devices in the space. Preferably, the or each detector comprises a WPAN transceiver, such as a Bluetooth transceiver, arranged to receive the mobile device addresses.

The space may include one or more entry/exit points through which users can enter or exit the space. In this case, a detector may be located at each one of the entry/exit points. In another example, detectors may be distributed throughout the space.

In a further embodiment of the invention, a method is provided for selecting content from a set of available content. The method comprises receiving a plurality of user identifier tags, obtaining content profiles comprising content preference data corresponding to the identifier tags, selecting content from the set based on the content preference data, and outputting the selected content.

In yet another embodiment of the invention, a method for creating a content profile is provided. The method comprises logging a user's content consumption to create content consumption data; creating, from the content consumption data, a content preference profile for the user; obtaining a unique identifier tag for the user; and combining the identifier tag with the content preference profile to create the content profile. Conveniently, the identifier tag is obtained from the user's mobile communication device.

Correspondingly, in another embodiment of the invention, a system for creating a content profile is provided. The system comprises a computer having a content output device, an identification device arranged to obtain a unique identifier tag associated with a user, a processor arranged to log information over time relating to content output via the output device, and a content profile generator arranged to generate a content profile comprising the identifier tag and the logged content-time information.

The invention extends, in a further embodiment, to a method for selecting content for delivery to a group of users, comprising creating a plurality of content profiles comprising unique identifier tags and content preference data, determining the users present in the group by detecting the identifier tags, and selecting content based on the content profiles of the users present in the group. In this embodiment, the identifier tags may be repeatedly detected so as to determine the users present in the group.

Correspondingly, the invention also extends, in a still further embodiment, to a system for selecting content for delivery to a group of users in a space, comprising a plurality of systems arranged to create content profiles, each content profile comprising a unique identifier tag and content preference data, and a content delivery system. The systems arranged to create content profiles each correspond to the system for creating a content profile described above, while the content delivery system comprises a detection system arranged to detect the identifier tags associated with users in the space, and a content selection system arranged to select content based on the content preference data of users in the space. Again, the content selection system corresponds to the content selection system described above.

### DESCRIPTION OF THE DRAWINGS

Preferred embodiments of the present invention will now be described, by way of example only, with reference to the accompanying drawings in which:

FIG. 1 is a schematic diagram of apparatus for implementing an embodiment of present invention;

FIG. 2 is a flowchart describing a process for creating and updating a content profile;

FIG. 3 is a schematic representation of a content profile and associated mobile device address;

FIG. 4 is a flowchart showing a process for maintaining a set of content profiles corresponding to current users of a space; and

FIGS. 5(a) and 5(b) show, schematically, two examples of how embodiments of the present invention could be implemented in a space.

### DETAILED DESCRIPTION OF PREFERRED EMBODIMENTS OF THE INVENTION

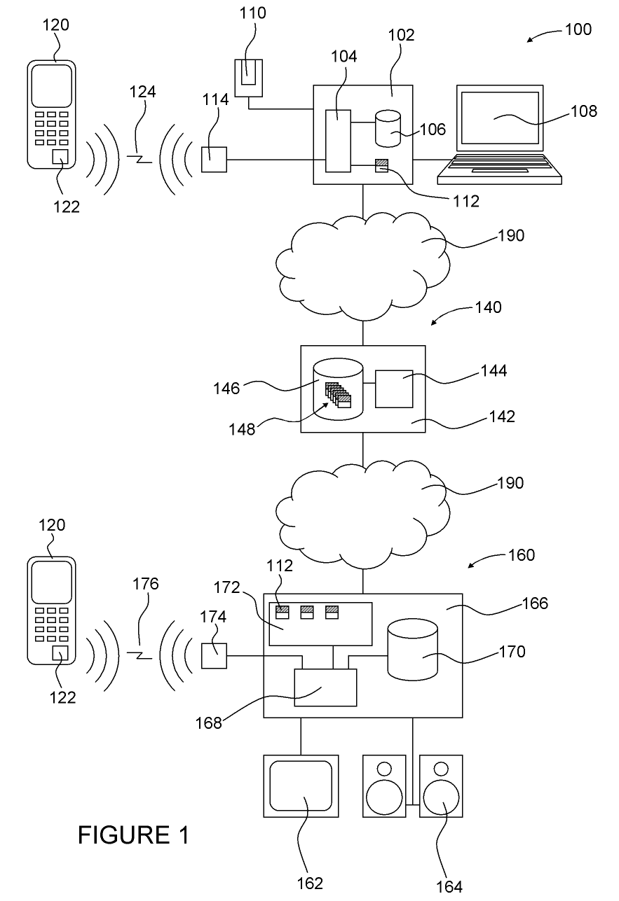

FIG. 1 shows, schematically, apparatus for implementing an embodiment of the present invention. The apparatus is divided into three parts, namely a home system 100, a profile server system 140, and a media output system 160. The three systems 100, 140, 160 communicate with one another via a network, such as the internet 190, and are generally arranged as follows.

The home system 100 is embodied as a personal computer in a user's home or place of work and would be used by the user for accessing, downloading, playing and otherwise dealing with media files such as music and video files. A user's personal computer can be adapted for use as a home system by the installation of suitable software on the computer. For example, the software may be downloaded by the user as part of a sign-up process to a web-based content preference service which implements an embodiment of the present invention.

The profile server system 140 is embodied as an internet server 142, located remotely from the home system 100 and the media output system 160 and connected to both via the internet 190. The profile server system 140 receives information from the home system 100 and transmits information to the media output system 160 in response to requests.

The media output system 160 is installed in a public space, such as a bar, restaurant, railway station, public square, or other urban environment, in which the user of the home system 100 may be present as part of an audience group. The media output system 160 controls the delivery of media to the audience group via output means arranged to output content to a content output device. The content output device is a media player which includes, for example, video screens 162 and loudspeakers 164. Furthermore, the media output system 160 is capable of detecting the presence of the user, sending a request to the profile server system 140 for information relating to that user, receiving information from the profile server system 140 and using the information in determining the media content to be delivered to the audience group.

In practice, a large number of home systems 100, with a corresponding number of individual users, communicate with one or more profile server systems 140 via the internet 190. Similarly, a large number of media content systems 160, deployed in different spaces and for different purposes, may communicate with the or each profile server system 140 via the internet 190. However, for simplicity, in the remainder of this description an apparatus comprising only one of each type of system 100, 140, 160 (as shown in FIG. 1) will be described except where the context demands otherwise.

Each of the systems will now be described in more detail.

The home system 100 includes a computer having a control unit 102, which in turn includes a processor 104 and a media store 106 (for example a hard disk drive). The media store 106 contains media files, such as music and video files. Output apparatus, such as a video monitor 108 and a loudspeaker system (not shown), are also provided. The processor 104 can access media files in the media store 106 and output their content on the output apparatus 108.

Each media file in the media store 106 is associated with metadata including, for example, the name of the artist, the title of the track, and the genre of the music.

Optionally, the home system 100 also includes a portable media player 110 which is connectable to the control unit 102 for the transfer of media files to and from the media store 106.

As will be explained in more detail below, the home system generates a content profile 112 based on the media consumption of the user of the home system, and transmits the content profile 112, via the internet 190, to the profile server system 140.

The user's media consumption can be recorded as media consumption data by the home system 100 in a number of ways, as will now be described.

In one example, a play count variable is added to the metadata associated with each media file in the media store 106. When the media file is played, the play count variable for that track is increased by an incremental value. If a portable media player 110 forms part of the home system 100, then play count information may be transferred to the control unit 102 from the portable media player 110 so as to account for media consumed via the portable media player 110. Media consumption data can then be obtained by extracting, from the metadata, a ranked list of the most-played tracks, artists, genres and so on.

In another example, a list of the media files stored in the media store 106 is created, including information about the artist, track title, genre and so on. A play count variable is also included in the list. The list may include information relating to media files not stored in the media store but which are instead stored and played on a portable media player 110 (using play count information transferred as described above) or on a remote server (not shown) via a website. The list can be ranked in order of the most-played tracks, artists, genres and so on, to provide the media consumption data.

In both examples, the play count variable may be time-dependent. For example, when a play count variable is increased to reflect a new playing of the track, the play count variable may be automatically decreased after a pre-determined period of time has elapsed. In this way, the media consumption data can reflect the current preferences of the user by including content-time information.

The control unit 102 of the home system is connected to a wireless personal area network (WPAN) transceiver 114, such as a Bluetooth (registered trademark) transceiver.

The user of the home system 100 has a mobile device 120, such as a mobile telephone, personal digital assistant (PDA) or portable computer, which is also equipped with a WPAN transceiver 122. In this way, the control unit 102 is connectable, by way of a WPAN 124, to the mobile device 120 when the mobile device 120 is within range of the control unit's WPAN transceiver 114.

The WPAN transceiver 122 in the mobile device 120 transmits, on request, a device address (denoted BD_ADDR in the Bluetooth standard) which is unique to that transceiver 122 and hence to that mobile device 120. The device address thus comprises an identifier tag arranged to uniquely identify the user's mobile device and, by association, the user. The control unit 102 can therefore obtain the device address of the user's mobile device 120 simply by transmitting a request to the mobile device 120. The mobile device address is stored in a memory of the control unit 102. If more than one Bluetooth-enabled device is discovered within range of the control unit's transceiver 114, then the user is prompted to select the appropriate mobile device 120 from a list of discovered devices.

The profile server system 140 includes a profile server 142 having a processor 144 and data storage apparatus 146, for example a hard drive. The data storage apparatus 146, known hereafter as a profile store, stores a plurality 148 of content profiles 112 received from a plurality of home systems (only one of which is shown in FIG. 1).

The processor 144 of the profile server 142 is arranged to receive requests from media output systems 160 connected to the profile server system 140 via the internet 190, and to transmit, in response to such a request, selected content profiles from the plurality 148 stored in the profile store 146 to the media output system 160 that issued the request.

The media output system 160 includes a controller 166 for providing output signals to drive the media output apparatus, in this case a video display screen 162 and a loudspeaker system 164. The controller further includes a processor 168, a data storage means or media store 170 (for example a hard disk drive) containing stored media files for output to the media output apparatus 162, 124, and data storage apparatus 172 for storing a list of current content profiles 112.

The controller 166 is connected, via input means, to a WPAN transceiver 174, so as to allow communication via a WPAN 176 between the controller 166 and mobile devices having WPAN transceivers and being in range of the controller's transceiver 174. In particular, the controller 166 is able to communicate with the mobile device 120 that previously connected to the home system 100. A given user's mobile device 120, therefore, is connectable both with that user's home system 100 and the media output system 160.

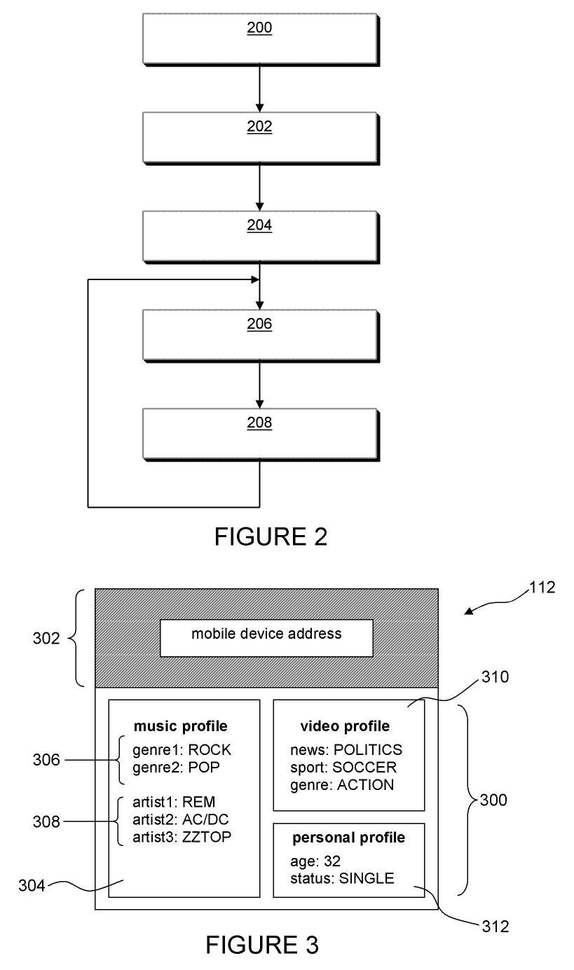

A method of creating, storing and updating a content profile 112, using the home system 100 and the profile server system 140, will now be described with reference to FIG. 2.

In summary, the process of creating, storing and updating a content profile 112 comprises, at step 200 of FIG. 2, creating a content profile based on media consumption, the associating a mobile device address with the content profile (step 202). At step 204, the content profile is uploaded to the profile server. The content profile can then be updated based on further media consumption (step 206), and the resulting updated content profile can then be uploaded to the profile server (step 208). Each of these steps will now be explained in more detail.

In step 200 of FIG. 2, the home system 100 creates a user-specific content profile 112 based on the content or media consumption data recorded as described above. To do so, the processor 104 analyses the media consumption data and converts the data to content preference information in a content profile format.

In step 202 of FIG. 2, the unique mobile device address, obtained from the user's mobile device 120 as described above, is associated with or included in the content profile 112.

The resulting content profile 112 is shown schematically in FIG. 3, and includes content preference information 300 and an associated mobile device address 302. In this way, the mobile device address 302 acts as an identifier or tag which uniquely identifies the content preference information 300 as corresponding to the preferences of the user who carries the mobile device 120.

Referring back to FIG. 2, in step 204 the content profile is transmitted, via the internet 190, and uploaded to the profile server system 140. A local copy of the content profile 112 is also stored in a memory of the home system 100.

In order to keep the content profile 112 stored on the profile server system 140 up to date, at step 206 in FIG. 2 the local stored version of the content profile 112 is updated to reflect recent changes to the media consumption data. The update in step 206 may be triggered for example in response to an instruction from the user, automatically after an update to the media consumption data, or after a pre-determined time period has elapsed since the last update.

In step 208 of FIG. 2, the updated content profile 112 is transmitted and uploaded to the profile server system 140 to overwrite the previously-uploaded content profile 112. Again, a local copy of the content profile 112 is stored in a memory of the home system 100.

Steps 206 and 208 of FIG. 2 are then repeated as often as necessary or practicable to keep the content profile 112 stored on the profile server system 140 up to date.

One purpose of the content profile 112 is to represent the user's preferences for media content, and the format of the content profile may vary according to the application. As mentioned above, one embodiment of a content profile format is shown schematically in FIG. 3. In this case, the preference information 300 of the content profile 112 includes a music content profile 304 including a list 306 of the two genres of music that the user must often listens to, and a list 308 of the three artists that the user most often listens to based on the media consumption data obtained by the home system 100.

The preference information 300 of the content profile 112 also includes a video content profile 310, which contains the user's preferences for news content (politics, in this example), sport content (soccer) and movie genre (action), again determined from the media consumption data.

The preference information 300 of the content profile 112 also includes a personal information profile 312, which in this example contains the age and marital status of the user. This information would be optionally submitted by the user, for example during the sign-up process to a web-based service for implementing an embodiment of the invention.

Referring again to FIG. 1, one role of the media output system 160 is to select, from the media store 170, appropriate content for delivery to users who form an audience group for the media output system 160. The controller 166 therefore provides a content selection system for selecting content for delivery to a group of users in a space, and the processor 168 is arranged to select content.

To select appropriate content, the media output system 160 maintains a set, or presence list 172, of content profiles 112, each content profile 112 in the presence list corresponding to a user who is present in the audience group. The processor 168 evaluates the set of content profiles 112 to select the most appropriate available content for delivery to the audience group, taking into account each user's preferences as indicated by the content profiles 112 in the presence list 172. In other words, the processor 168 of the media output system 160 is arranged to select content from the media store 170 based on content preference data from the stored content profiles 112 in the presence list 172, which correspond to those content profiles 112 that have an identifier tag (i.e. a Bluetooth address) that matches one of the identifier tags received via the WPAN transceiver 174.

To aid the selection of content, the content stored in the data store 170 is associated with metadata, in the same way as the content stored in the media store 106 of the home system 100. The content preference information contained in the content profile 112 is compatible with the metadata.

To perform the selection, the processor 168 is arranged to evaluate the set of content profiles 112. In one embodiment, the processor 168 applies a statistical algorithm that is appropriate for the type of media output required and the environment in which the media output system is deployed.

For example, if the output is news articles delivered via a video screen 162, then the processor 168 may count, for each possible category of news content, the number of content profiles 112 in the presence list 172 that cite that category as the user's preferred category. In other words, the content preference data is classified by content category. The processor 168 then selects for delivery news articles with content that falls into the category which is cited as preferred in the greatest number of content profiles 112 in the presence list 172.

In another example, when the output is music to be played in a bar via a loudspeaker system 164, the processor 168 may use a more complex algorithm to select appropriate music. For instance, the processor 168 may retrieve, from an internal or external database (not shown), information on related artists. In this context, related artists are groups of artists who tend to be cited together by individuals. The processor 168 would then select for delivery music tracks by artists who were cited in several content profiles 112 in the presence list, or who are related to such artists according to the related artists information.

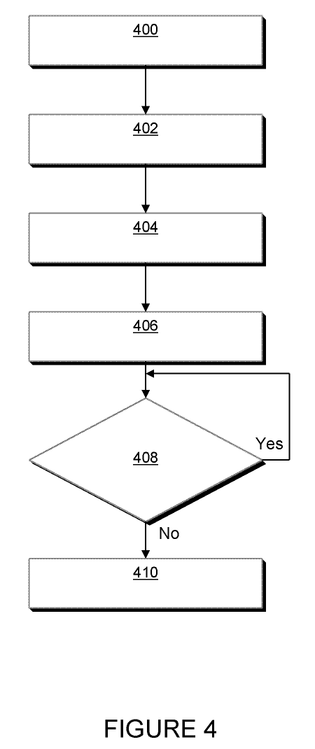

Referring now to FIG. 4, a method for creating and maintaining a presence list will now be described. In summary, in step 400 of FIG. 4, the mobile device 120 is detected by the media output system 160. In step 402, the device address is retrieved from the mobile device 120. In step 404, the content profile 112 associated with the mobile device address is retrieved from the profile server system 140. At step 406, the content profile 112 is added to the presence list. At step 408, the system determines whether the mobile device 120 is still detectable. If so, step 408 is repeated. If the mobile device 120 is not detectable in step 408, at step 410 the content profile 112 is removed from the presence list.

The media output system 160 incorporates, in its processor 166, a user detection system which is configured to continually scan for the presence of Bluetooth-enabled mobile devices via the WPAN transceiver 174 of the media output system 160. In step 400 of FIG. 4, when a Bluetooth-enabled mobile device 120 enters into range of the WPAN transceiver 174 of the media output system 160, a device address request is transmitted from the media output system 160 to the mobile device 120.

The mobile device 120 responds to the request by transmitting its unique device address back to the media output system 160 (step 402 in FIG. 4). The media output system 160 then sends a request, via the internet 190, to the profile server system 140. The request contains the device address of the mobile device 120. The profile server system 140 responds to the request by retrieving the content profile 112 associated with the indicated device address and transmitting it to the media output system 160 (step 404 in FIG. 4). If no content profile is associated with the indicated device address, the profile server system 140 responds to the request with an appropriate message, and the media output system 160 thereafter ignores that mobile device.

In this way, the processor 168 is arranged to check each identifier tag or device address received by the WPAN transceiver against the plurality 148 of stored content profiles in the server system 140.

Once the content profile 112 has been retrieved from the profile server system 140, the content profile 112 is added to the presence list 172 (step 406 in FIG. 4). As described above, that content profile 112, and hence the user's preferences, are then taken into account when the media output system 160 selects content for delivery to the audience group.

In step 408 of FIG. 4, the media output system 160 performs a check to determine whether the mobile device 120 is still present within the WPAN 176. Such a check is performed periodically. If the mobile device 120 can still be detected by the media output system 160, then no action is taken and the check of step 408 is repeated.

If, however, the mobile device 120 can no longer be detected by the media output system 160, then, in step 410 of FIG. 4, the content profile is removed from the presence list 172 to reflect that user's departure from the audience group.

By performing the method of FIG. 4 for a large number of mobile devices, a presence list 172 containing content profiles associated with many individuals within the audience group can be maintained.

It will be appreciated that it may be desirable to add a content profile 112 to the presence list 172 only for those users who are present in a space for a period of time and who can be assumed to be paying attention to the media output. It is therefore necessary to distinguish between users who have joined the audience group from users who are passing through the space without joining the audience group.

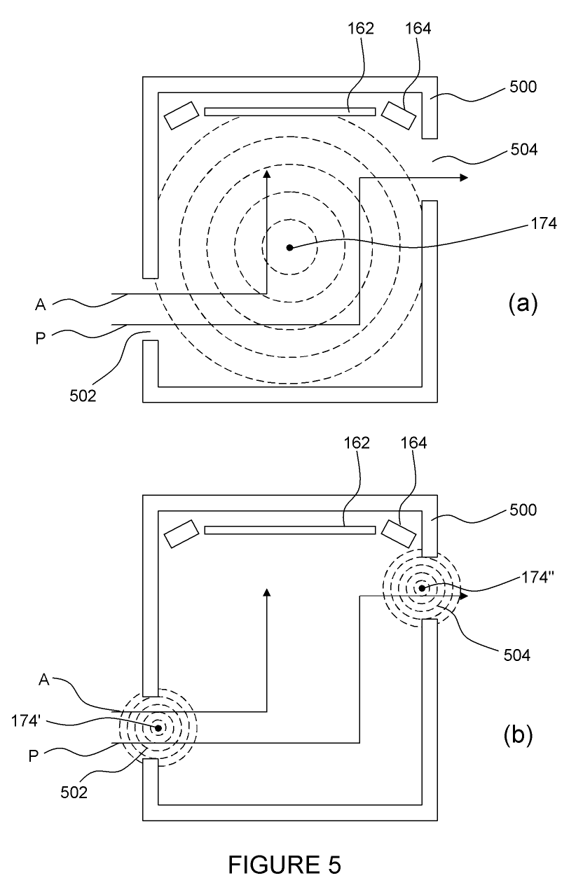

An example of how users can be identified as having joined an audience group will now be explained with reference to FIG. 5(a), which shows a media output system arranged within a room 500. A video screen 162 and loudspeaker system 164 of the media output system are arranged to deliver content to the audience group within the room 500.

A Bluetooth transceiver 174 of the media output system is located approximately centrally in the room 500. As illustrated by the dashed lines in FIG. 5(a), the range of the Bluetooth transceiver 174 extends to cover most of the space within the room 500.

The room has two entry/exit points or doors 502, 504 through which users may enter or exit the room 500. So, an individual may enter the room through one of the doors 502 and stay in the room 500 for a time, thus forming part of the audience group. The path of such an individual is labelled A in FIG. 5(a). Another individual, whose path is labelled P in FIG. 5(a), enters the room 500 through one of the doors 502, passes through the room 500, and then leaves through the other door 504 without staying in the room 500 for any appreciable length of time. This individual does not become part of the audience group.

Discrimination between individuals following paths A and P in FIG. 5(a) is achieved by monitoring the length of time over which each individual's mobile device 120 can be detected by the media output system. So, when a mobile device 120 is initially detected, its device address is retrieved (step 402 in FIG. 4) but the associated content profile 112 is not yet requested from the profile server system 140. Instead, the media output system stores the device address in a memory.

After a pre-determined time period, the media output system checks whether the device 120 having the stored device address is still detectable, which would be indicative that the user has joined the audience group. If, as in the case of path A, the device is still detectable, the media output system proceeds to request the content profile 112 associated with that device address (step 404 in FIG. 4). If, however, the device having the stored device address is no longer detectable, which would be the case for path P, then the user is assumed to have left the room and the content profile is not requested. Instead, the device address is deleted from the memory and no further action is taken.

Another example, suitable for a larger space, is shown in FIG. 5(b). The media output system includes two independently-addressable Bluetooth transceivers 174′, 174″, one located at each door 502, 504 to the room 500. The range of each transceiver 174′, 174″ is such that each transceiver can detect mobile devices 120 only in the vicinity of the doors 502, 504, as shown by the dashed lines in FIG. 5(b). Otherwise, the situation is the same as in FIG. 5(a).

In the FIG. 5(b) case, discrimination between users following the paths labelled A and P can be achieved as follows. When a user enters the room 500, their mobile device 120 is detected by a first one 174′ of the Bluetooth transceivers of the media output system and its device address is retrieved (step 402 in FIG. 4). The associated content profile 112 is not yet requested from the profile server system 140, but instead the device address is stored in a memory.

If, within a pre-determined time period, the mobile device 120 having the stored device address is detected by the other one 174″ of the Bluetooth transceivers of the media output system, as would be the case for path P, or by the same Bluetooth transceiver 174′ (as would be the case if an individual exited the room through the same door they entered by) it is assumed that the user has left the room 500 without joining the audience group and the content profile is not requested. Instead, the device address is deleted from the memory and no further action is taken.

If, however, there is no further detection of the mobile device 120, then it is assumed that the user is still present in the room and has joined the audience group, as would be the case for path A. The media output system then proceeds to request the content profile 112 associated with that device address (step 404 in FIG. 4).

In the FIG. 5(b) example, the method of maintaining the presence list shown in FIG. 4 is modified so that, in steps 408 and 410 of FIG. 4, the content profile is removed from the presence list when the mobile device is once again detected by one of the Bluetooth transceivers 174′, 174″ of the media output system.

It will be appreciated that the number and location of the Bluetooth transceivers of the media output system can be varied depending on the space in which the media output system is deployed so as to provide the desired balance between the accuracy of the presence list and the complexity, and therefore the cost, of the system.

It is, for example, conceivable that Bluetooth transceivers could be positioned throughout a space to allow the location of individual users within the space to be determined by the media output system. Such a system could be used, for example, to deliver appropriate advertisements to a user as they progress through a retail environment.

It will be appreciated that many variations and modifications could be made to the embodiments described above. Some possible variations and modifications will now be described by way of example.

In some environments, for example where individuals frequently enter and leave the audience group or where the presence of an individual in the audience group tends to last only a short time, it may be desirable for the media output system to obtain a content profile from the profile server as soon as that individual's mobile device has been detected as being part of the audience group, as shown in FIG. 4. In this way, the media output system can respond rapidly to the changing audience group.

In other cases, such as in bars and restaurants, individuals tend to enter and leave the audience group less frequently, and tend to stay in the audience group for longer periods of time. In such cases, it may be sufficient for the media output system to obtain content profiles from the profile server less frequently. In one embodiment, therefore, the media output system stores the device addresses received over a pre-defined period of time and, when that time period elapses, requests from the profile server system content profiles corresponding to all of the device addresses in a batch request.

In the embodiments described above, the music profile data and video profile data in a user's content profile is generated automatically, based on the media consumption data recorded by the user's home system. In some cases, it may be desirable to allow editing by the user of the music profile data and video profile data of the content profile. Accordingly, in one embodiment, the content profile may be edited via a suitable user interface. The interface may allow the user to directly select their preferred music and video genres, and so on. The interface then modifies the user's content to reflect the selected preferences.

The content profile may include negative preferences, for example that the associated user particularly dislikes a certain music artist or a certain sport. Negative preferences may be determined from the media consumption data recorded by the home system (for example, by setting a certain parameter as disliked if content relating to that parameter is never consumed by the user even when it is available). Alternatively, or in addition, negative preferences could be indicated directly by the user via a user interface as described above.

It will be appreciated that, in many circumstances, not all of the members of an audience group will be users of the content profile service. As a result, the preferences of the audience group as a whole determined by embodiments of the present invention may not reflect the preferences of all members of the audience group. Instead, the determined preferences relate only to those members of the audience group who are users of the service. This factor may optionally be taken into account by the media output system when selecting media files for delivery. For example, the preferences of the audience group as a whole, determined in accordance with the embodiments described above, may be moderated by the inclusion of a pre-defined generic content profile expected to match the preferences of individuals in the audience group who are not users of the service. The weighting given to the generic content profile can be set so as to reflect the expected ratio of non-users to users in the audience group.

Some of the functions described as being performed by the home system in the above embodiments could instead be performed remote from the home system by the profile server system.

The home system may, for instance, transmit component parts of the content profile to the profile server system. For example, the home system may transmit media consumption data as list of recently-consumed media files, together with the mobile device address, to the profile server. The processor of the profile server then creates a content profile based on the information received from the home system, and stores the content profile in the profile store.

Similarly, some of the functions described as being performed by the media output system in the above embodiments could instead be performed by the profile server system. For example, the presence list maintained by the media output system may consist only of a list of mobile device addresses. In that case, the media output system transmits the presence list to the profile server system. The processor of the profile server then retrieves the content profiles corresponding to the device addresses in the presence list, and then itself performs an evaluation of the media preferences of the associated users. The results of the evaluation, for example in the format of a single content profile which reflect the audience group's preferences as a whole, are then transmitted back to the media output system. The processor of the media output system then selects media files for output based on this single content profile.

In another embodiment, the profile server is, instead of being remote from the media output system, incorporated within the media output system. In this case, the content profiles are retrieved from a local source such as a local data store.

1. A content selection system for selecting content for delivery to a group of users in a space, the system comprising:
inputs arranged to receive a plurality of identifier tags, each identifier tag being arranged to uniquely identify a user;
data storage apparatus arranged to store content for selection;
a processor arranged to select content; and
outputs arranged to output the selected content to a content output device;
wherein:
the processor is arranged to check each identifier tag received by the input means against a plurality of stored content profiles, each content profile comprising a user's identifier tag and data relating to the user's content preferences;
the processor being arranged to select content from the data storage apparatus based on content preference data from stored content profiles that have an identifier tag that matches one of the received plurality of identifier tags.

2. A content selection system as claimed in claim 1, wherein the content stored in the data storage apparatus is associated with metadata and wherein the content preference data of the content profiles is compatible with the metadata.

3. A content selection system as claimed in claim 1, wherein the inputs are arranged to receive the plurality of identifier tags from a wireless personal area network transceiver.

4. A content selection system as claimed in claim 3, wherein each identifier tag relates to a user's mobile communication device.

5. A content selection system as claimed in claim 4, wherein the wireless personal area network transceiver is a Bluetooth transceiver and the mobile device is a Bluetooth-enabled device, and wherein the identifier tag is a Bluetooth device address of the mobile device.

6. A content selection system as claimed in claim 1, wherein content preference data is classified by content category.

7. A content selection system as claimed in claim 6, wherein the processor is arranged to select content according to the most preferred content category.

8. A content selection system as claimed in claim 6, wherein the processor is arranged to select content based on a statistical analysis of the content preference data.

9. A content selection system as claimed in claim 1, wherein the system is arranged to retrieve stored content profiles from a remote source.

10. A content selection system as claimed in claim 1, wherein the outputs comprise a media player.

11. A system for delivering content to a group of users in a space, the system comprising:
a content selection system as claimed in claim 1; and
a user detection system arranged to detect identifier tags corresponding to users in the space and to provide the detected identifier tags to the inputs of the content selection system.

12. A system for delivering content as claimed in claim 11, wherein the identifier tags comprise device addresses of user's mobile devices and wherein the user detection system comprises one or more detectors arranged to detect mobile devices in the space.

13. A system for delivering content as claimed in claim 12, wherein the or each detector comprises a wireless personal area network transceiver arranged to receive the device addresses.

14. A system for delivering content as claimed in claim 12, wherein the space includes one or more entry/exit points through which users can enter or exit the space, and wherein a detector is located at each one of the entry/exit points.

15. A method for selecting content from a set of available content, comprising:
receiving a plurality of user identifier tags;
obtaining content profiles comprising content preference data corresponding to the identifier tags;
selecting content from the set based on the content preference data; and
outputting the selected content.

16.-21. (canceled)
